(19) United States
(12) Patent Application Publication
(10) Pub. No.: US 2014/0096213 A1
(43) Pub. Date: Apr. 3, 2014

(54) METHOD AND SYSTEM FOR DISTRIBUTED CREDENTIAL USAGE FOR ANDROID BASED AND OTHER RESTRICTED ENVIRONMENT DEVICES

(71) Applicants: Kevin QUAN, Toronto (CA); Kai Cheung, Toronto (CA)

(72) Inventors: Kevin QUAN, Toronto (CA); Kai Cheung, Toronto (CA)

(21) Appl. No.: 13/630,111

(22) Filed: Sep. 28, 2012

(51) Int. Cl. H04L 29/06

(52) U.S. Cl. CPC H04L 63/08
USPC 726/7

(57) ABSTRACT

A method, system and computer program product configured for providing distributed credential usage for an electronic handheld device or computing device configured with an operating system comprising an iOS based, Android or other operating system with sandboxed or restricted environments. The system comprises one or more applications running an operating system and configured with one or more sandboxed environments, and a credential provider application configured in a sandboxed environment. The credential provider application is configured to transfer data between the applications, for example, utilizing an inter-process communication channel. The credential provider application is configured to perform an operation on a request from one of the applications and utilizes credentials associated with the application. The credential provider application is configured to maintain the integrity of the credentials within the confines of the credential provider application so that the application is not given access to any private or secret credentials.

### FIELD OF THE INVENTION

This invention relates to electronic devices, and more particularly to a method and system for providing distributed credential usage for an electronic handheld device or computing device configured with an operating system comprising restricted environments such an Android, iOS, or other operating system with sandbox environments.

### BACKGROUND OF THE INVENTION

Public Key Infrastructure or PKI cryptography is a well know technique for securing digital information or data between two sources or parties, i.e. a sender and a recipient. PKI utilizes public/private key pairs for encryption and decryption. The security of PKI cryptography is based on a party's private key(s) being kept secret or confidential. In the context of the present description, a private key and public key (i.e. certificate) pair is referred to as a credential.

With PKI, the same credential can be used within a variety of applications. While there is some security risk, it is also feasible to use the same credential between multiple applications. This has the effect of limiting both user complexity and confusion, as well as streamlining application integration. It will be appreciated, for instance, that if each application uses a different decryption key, then each party wishing to encrypt information for the application must have some means of retrieving the corresponding encryption key for the application.

It will further be appreciated that retrieving an encryption key for an application is a distributed computing issue as the encrypted information is typically transmitted across application and/or system boundaries. On current desktop platforms, one solution involves retrieving credentials from a centralized source, such as the “cloud” (i.e. the Internet). This approach may be further optimized by having a single credentials provider within a system that manages and retrieves credentials from the centralized source; and further acts as a proxy to enable heterogeneous applications to work with the credentials. This approach is based on the following considerations: the operation system defines a system-level service with a specific set of interface points which can be used to provide and retrieve credentials; applications are implicitly (or explicitly through user action) trusted to access the system-level credential service; and many applications have extensibility points which allow tightly coupled and verifiable integration.

It will, however, be appreciated that there will be computing environments where some or not all of these considerations are satisfied. For instance, the operating system does not provide an interface or facility to store or access credentials; applications are discretely separated, i.e. run at a user-level (as opposed to privileged/root/system level) within individual processes and the inter-process communication (IPC) is restricted in size and type; or there does not exist any shared storage, whether in memory or a file system or in other devices, which applications can use to write or read from without explicit user action or permission.

Typical examples of environments with these restrictions are mobile environments such as the iOS operating system from Apple, the Android operating system from Google, and other sandbox environments. In these environments, the ability for an arbitrary or unrelated application to access credentials is severely restricted by the constraints for example, as described above.

Accordingly, there remains a need for improvement in the art.

### BRIEF SUMMARY OF THE INVENTION

The present invention is directed to a method, computer program product and system for providing distributed credential usage for an electronic device and other types of computing devices configured with a restricted or constrained environment, such an iOS based operating system or an Android based operating system, or other sandbox based environments.

According to an embodiment, the present invention comprises a device configured for executing an application, the device comprises: an operating system with a restricted environment configured to run the application; a credential provider module configured to run in a restricted environment on the operating system, and comprising an inter-process communication path configured to transfer data between the application and the credential provider module; the credential provider module comprising a verifiable identity configured to be verified by the application; the credential provider module comprising a credential component configured to store one or more credentials associated with a user within the credential provider module, and a processing component configured to utilize the one or more credentials and further configured to perform one or more operations based on a request from the application.

According to another embodiment, the present invention comprises a computer-implemented method for performing an operation associated with a user in a restricted environment, said computer-implemented method comprising the steps of: running an application in the restricted environment; running a credential provider application, said credential provider application having an identity and being configured for storing one more credentials associated with the user and maintaining said one or more credentials within said credential provider application; verifying the identity of said credential provider application; generating an argument at said application, said argument being associated with the operation; sending said argument to said application; performing the operation at said credential provider application utilizing said argument and said one or more credentials associated with the user, and generating a result from said operation intended for said application; and sending said result back to said application.

According to another embodiment, the present invention comprises a computer program product for performing an operation associated with a user in a sandboxed environment, said computer program product comprising: a computer readable storage media configured for storing instructions executable by a processor, said executable instructions comprising instructions for, running an application in the sandboxed environment; running a credential provider application, said credential provider application having an identity and being configured for storing one more credentials associated with the user and maintaining said one or more credentials within said credential provider application; verifying the identity of said credential provider application; generating an argument at said application, said argument being associated with the operation; sending said argument to said application; performing the operation at said credential provider application utilizing said argument and said one or more credentials associated with the user, and generating a result from said operation intended for said application; and sending said result back to said application.

According to another embodiment, the present invention comprises a system for providing distributed credential usage within a restricted computing environment, said system comprising: an application configured to run and process data within a separated environment running on an operating system; a credential provider application configured to run within a separated environment and transfer data to and from said application utilizing inter-process communication, said credential provider application having a verifiable identity, and being configured to store one or more credentials associated with said application or a user associated with said application, and further configured to contain said one or more credentials within the boundaries of said credential provider application; said application being configured to verify the identity of said credential provider application, and based on said verification generate a request for performing an operation on data associated with said application; said application being configured to transfer said request to said credential provider application through said inter-process communication; said credential provider application being configured to perform said operation based on said request from said application to generate a result for said application, and said credential provider application utilizing said one or more credentials as needed within the boundaries of said credential provider application and without releasing any of said one or more credentials to said application or any other requesting party; and said credential provider application being configured to send said result to said application.

Other aspects and features of the present invention will become apparent to those ordinarily skilled in the art upon review of the following exemplary embodiments of the invention in conjunction with the accompanying figures.

### BRIEF DESCRIPTION OF THE DRAWINGS

Reference will now be made to the accompanying drawings, which show by way of example, embodiments according to the present invention, and in which:

FIG. 1 is a block diagram showing a typical architecture for an application within a sandbox based environment configured with a mechanism for providing distributed credential usage according to an embodiment of the present invention;

FIG. 2 is a logic or processing flow-diagram showing a process for utilizing credentials in an application according to an embodiment of the present invention;

FIG. 3 is a logic or processing flow-diagram showing a process for retrieving arguments for an application according to an embodiment of the present invention;

FIG. 4 is a data flow-diagram showing a process for transferring a large argument for example in response to a retrieval request according to an embodiment of the present invention;

FIG. 5 is a logic or processing flow-diagram showing a process for performing an operation in an application utilizing credentials according to an embodiment of the present invention; and

FIG. 6 is a logic or processing flow-diagram showing a process for retrieving and/or caching credentials from the cloud according to an embodiment of the present invention.

Like reference numerals indicate like elements or components in the drawings.

### DETAILED DESCRIPTION OF THE EMBODIMENTS

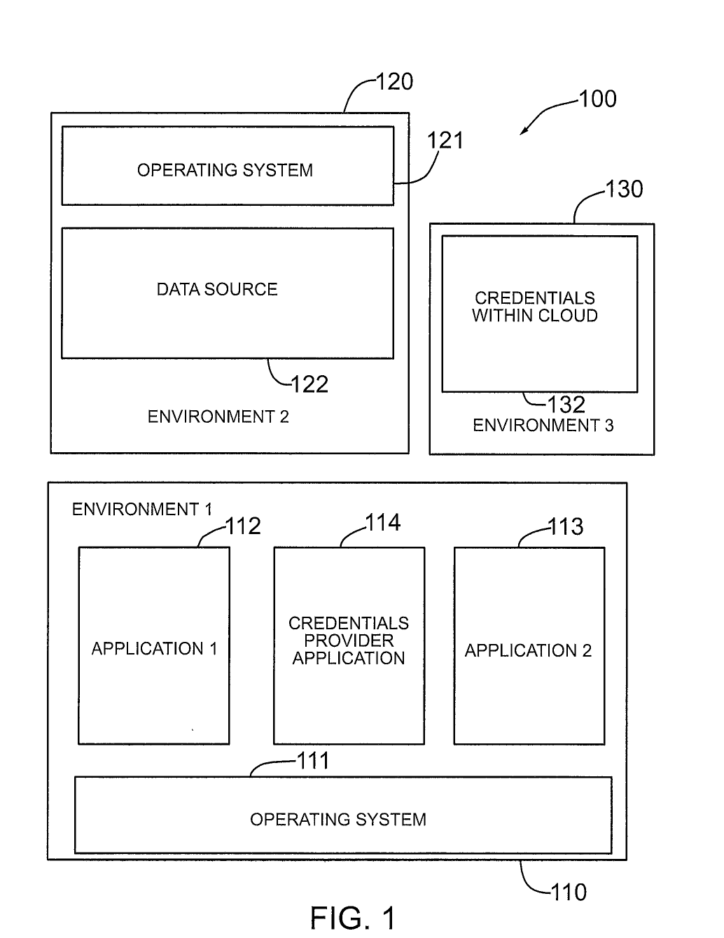

Reference is made to FIG. 1, which shows in diagrammatic form an exemplary system incorporating a mechanism and method for distributing credentials within a constrained or restricted environment, for example, a sandbox based environment in an Android based device according to an embodiment of the invention, and indicated generally by reference 100.

The system 100 comprises a first restrictive or constrained environment, “Environment 1”, indicated generally by reference 110, a second restrictive or constrained environment, “Environment 2”, indicated generally by reference 120, and a third environment indicated generally by reference 130 configured for an electronic computing or communication device. The electronic device may comprise, for example, an iOS based device such as the iPhone™ handheld device from Apple Inc. or an Android based device, or another type of computing device such as an iPAD™ device, also from Apple Inc., a notebook computer, a desktop computer, etc. The electronic device is configured in known manner with one or more processors, memory, a communication component or module configured for communication with other computing devices and/or networks, such as WI-FI networks and the Internet. The environments are configured in memory, as described in more detail below.

As shown in FIG. 1, the first environment 110 comprises an operating system module or component 111, a first application 112, a second application 113 and a credentials provider application indicated generally by reference 114. The applications 112, 113 comprise user-level applications within the environment 110 and are configured in device memory and exist (i.e. run) on top of the operating system 111. The credentials provider application 114 is configured to provide the first and/or second applications 112, 113 with credentials, as will be described in more detail below. According to another aspect, the credential provider application 114 also comprises a user-level application and runs on top of the operating system. The second environment 120 according to an exemplary embodiment comprises a module or component having an operating system 121 and a data source or repository 122. The data source 122 is configured for encrypting/decrypting data, for example, utilizing PKI (Public Key Infrastructure) cryptography, as will be described in more detail below. According to another aspect, the data source 122 is configured to encrypt data for decryption by the second application 113, and/or signing data for verification by the second application 113, as will be described in more detail below. The third environment 130 comprises a system or application configured for storing and providing credentials. According to an exemplary embodiment, the third environment 130 comprises a “cloud” based credentials module or component 132 configured for securely delivering credentials over the “cloud”, e.g. the Internet, to the credential provider application 114 and/or the data source module 122, as will be described in more detail below. According to another aspect, the applications comprise discretely separated applications that are configured to run at a user-level (as opposed to running on a privileged/root/system level) within individual processes and inter-process communication (IPC) may be limited in size and/or type. In addition, shared storage, whether in memory or system file(s) or with other devices, may not exist or be configurable, and as a result applications are not able to write or read shared data.

In the present description, the credentials provider system, mechanism and method is described in the context of an electronic device, or an electronic device configured with a communication capability or facility, running or based on the Android operating system from Google Inc. It will however be appreciated that the mechanism and/or method is suitable in part, or whole, to other operating systems or applications comprising a similar security structure or facility, or to other types of handheld device, computers, or computing devices, for example, devices running the iOS operating system or platform from Apple Inc.

According to an embodiment, the credentials provider 114 is configured to control the storage and/or usage of credentials (e.g. keys and/or passwords), and may be further configured to perform operations or processing using the credentials as requested, for example, by the applications(s) 112 and/113. The operations or processing comprise encryption/decryption, digital signing, and/or verification of a digital signature, as will also be described in more detail below. According to a further aspect, the credentials provider 114 is configured to maintain the security of the credentials, i.e. by not exposing any of the credentials or any other private data to the applications 112, 113. It will be appreciated that this configuration provides a mechanism to help prevent malicious attacks on the user's credentials and the device. One form of malicious attack involves creating (i.e. installing) a malicious application which is configured to take or harvest private data (e.g. keys and/or passwords) associated with the user and/or device. According to an embodiment, the credential provider 114 is configured not to provide or share private data with the applications 112, 113, as will be described in more detail below. This configuration makes it difficult for an application, legitimate or malicious, to retrieve or access private data, or perform other operations utilizing the private data of the user, or, for example, tricking the user into performing any number of arbitrary operations.

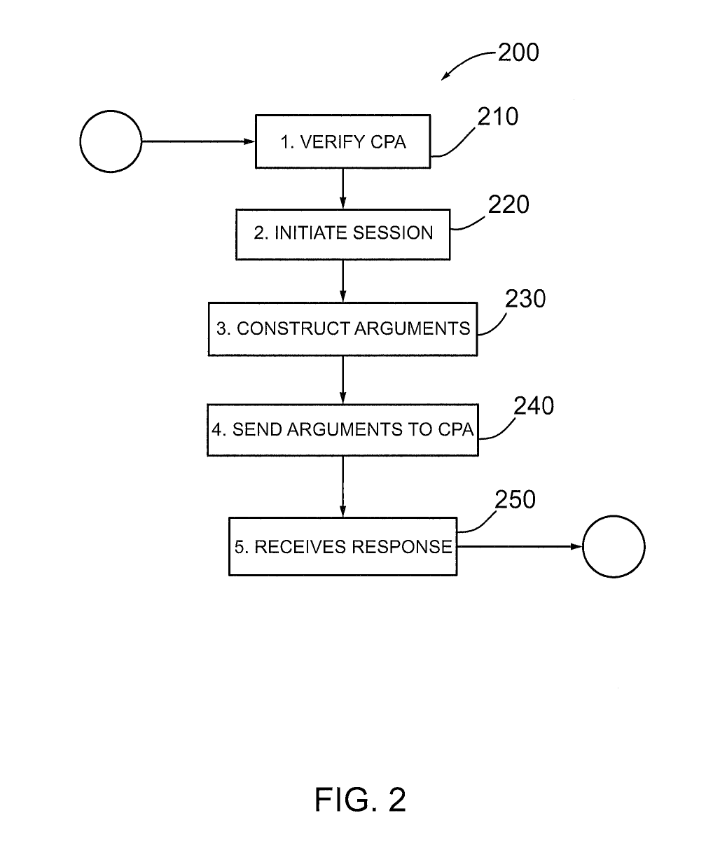

According to an embodiment, the applications 112 and/or 113 are configured to perform PKI or cryptographic operations, such as, encrypting, signing, decrypting, verifying, and the like. The system 100 of FIG. 1 can be configured to perform the following exemplary operations:
the first application 112 (or the second application 113) encrypts data for the data source 122
the data source 122 encrypts data for decryption at the second application 113 (or at the first application 112)
the first application 112 (or the second application 113) signs data, and the data source 122 verifies the signature
the data source signs data, and the second application 113 (or the first application 112) verifies the signature
   It will be appreciated that the system 100 may be configured to perform additional operations and/or variations of the operations listed above. The operation of the system 100 according to embodiments of the present invention is described in further detail below with reference to FIG. 2.

Reference is made to FIG. 2, which shows a process according to an embodiment of the present invention for the first application 112 to encrypt data for the data source 122 utilizing credentials associated with the user. The process is indicated generally by reference 200, and comprises the application 112 verifying the identity of the credential provider application 114, as indicated by reference 210. The verification step 210 provides a check for ensuring that the credential provider 114 is not being impersonated under a malicious attack in an attempt to gain access to private data associated with the user or device, for example, by requesting the user to provide authentication information. The process 200 comprises an initiate session operation as indicated by reference 220. While an inter-process communication (IPC) channel between the application 112 and the credential provider 114 may utilized for transferring data, the IPC channel by itself can be insecure or compromised. According to an embodiment, the system is configured to create or generate a shared secret that is used to protect (e.g. encrypt) data (e.g. arguments) being transferred from the application 112 to the credential provider 114 via an IPC and data sent from the credential provider 114 to the application 112. According to an exemplary implementation, the encryption utilizing a shared secret is implemented with a cryptography algorithm, such as, Advanced Encrypting Standard (AES) while the establishment of a shared secret is implemented with a cryptographic algorithm, such as, Diffie-Hellman key exchange. The process 200 is configured to create or enumerate one or more arguments required by the credential provider 114 as indicated by reference 230. According to another aspect, the arguments may be encrypted to provide an additional layer of security or protection. According to an exemplary implementation, the following arguments may be utilized:

| | | Requires | |
|---|---|---|---|
| Name | Description | Encryption | Comments |
| Public | Identifies which shared | No | Multiple |
| session | session secret CPA | | applications may be |
| identifier | should use | | accessing CPA at |
| | | | one time, therefore |
| | | | an identifier is |
| | | | necessary |
| Argument | Provides backward | No | |
| list | compatibility in case | | |
| version | the argument schema | | |
| | changes | | |
| Credential | Identifies which | Yes | Multiple credentials |
| identification | credential to be | | may exist on the |
| | used for the | | system, but only one |
| | operation | | should be used by |
| | | | this operation |
| Operation | The operation which | Yes | |
| to perform | CPA will perform | | |
| Operation | Any arguments that | Yes | |
| argument(s) | the operation will | | |
| | require | | |

It will be appreciated that the arguments as shown in the above table are exemplary, and other arguments or different types of arguments may be utilized.

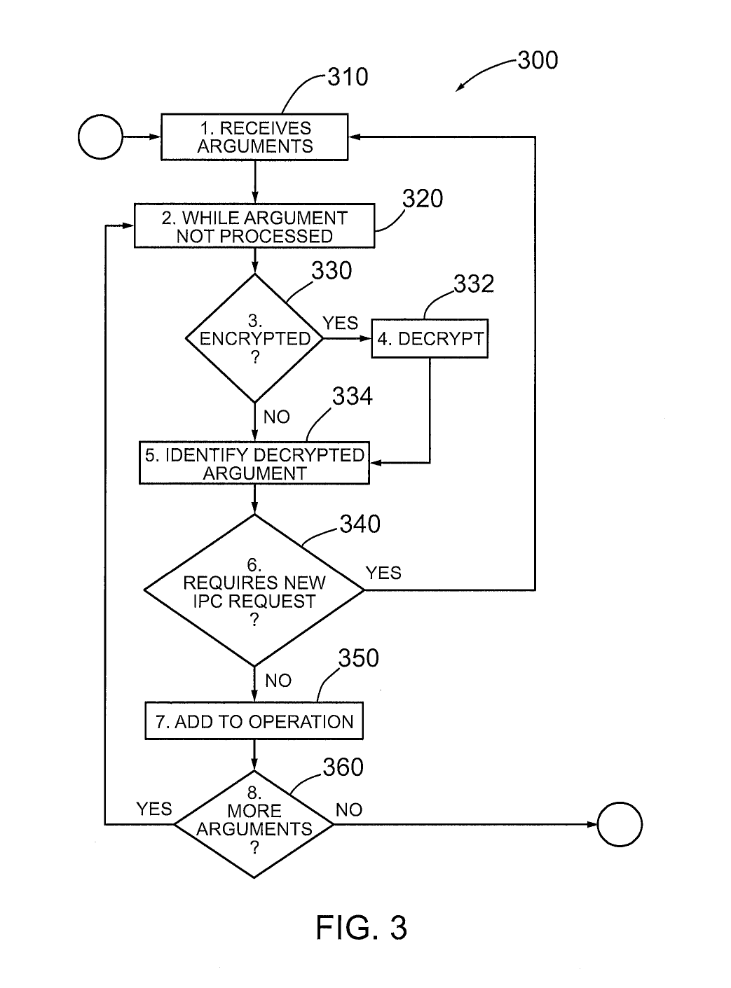

Referring again to FIG. 2, the process 200 is configured to send the operation arguments (i.e. once constructed as indicated by processing step 230) to the credential provider 114 via the IPC, as indicated by reference 240. It will be appreciated that there may be instances where the operation arguments may be quite large in size, for example, if the operation comprises encrypting or signing a picture or other large file or data. The size of the arguments may exceed the size limit of the IPC (in known manner size limits are typically introduced to ensure that a single IPC does not introduce significant delay into the overall responsiveness of a system). According to another aspect, the process 200 is configured to provide or pass a pointer in the initial argument list, instead of the large argument. The pointer comprises information for retrieving the argument, and comprises, for example, a description of a subsequent IPC request or a uniform resource indicator (URI). It will be appreciated that breaking a single (large) IPC request into multiple IPC requests allows the operating system to schedule the requests in a manner that doesn't degrade performance as abruptly as a single large request. However, the overall operation requested by the calling application will typically require a longer period of time to complete. A process for transferring or passing “large” arguments through multiple IPC requests according to an embodiment of the invention is described in more detail below with reference to FIG. 3.

Referring again to FIG. 2, the credential provider 114 is configured to receive the argument(s) and perform one or more operations to generate a result for the requesting application. The process 200 is configured to pass the result back to the application 112, as indicated by reference 250. According to one aspect, the result (i.e. data or information) generated by the credential provider 114 is encrypted with the same session key as utilized in step 240. Since the result generated by the credential provider 114 is passed across process boundaries, size limitations may arise as described above, and according the result may need to be broken or divided into smaller segments.

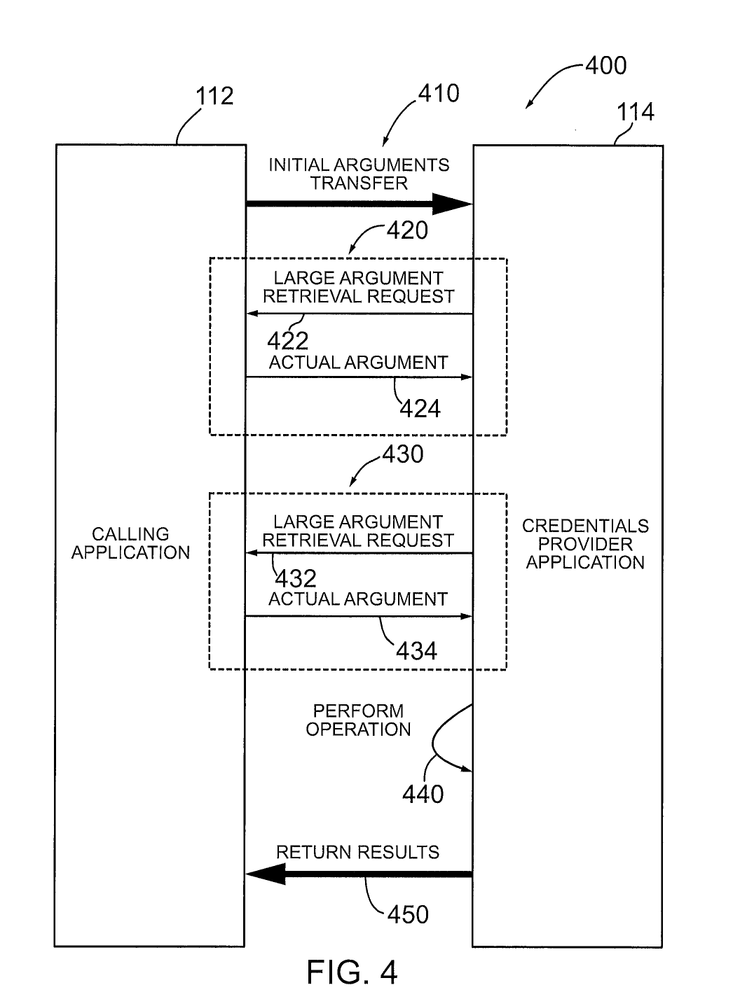

Reference is next made to FIG. 3, which shows a process for retrieving arguments for an application according to an embodiment of the invention and indicated generally by reference 300. As described, the process 300 is suitable for passing result data or arguments that may exceed the size limits of the IPC. The process 300 includes a first step comprising receiving an argument or arguments (e.g. a list of arguments) at the credential provider 114 (FIG. 1), or the credential provider 114 returning a result or a list of results to the calling application (e.g. the first application 112 in FIG. 1). The process 300 includes one or more processing operations, which may be configured as a loop processing structure, indicated generally by reference 320, i.e. each item in the list is processed individually within the loop structure 320. As described above, the argument and/or result may be encrypted. The process 300 determines in decision block 330 if the item (i.e. argument or result) is encrypted, and if yes, the process 300 is configured to decrypt the item, as indicated by reference 324. If the item is not encrypted (as determined in 330) or decrypted (i.e. decrypted in 332), then the processing logic continues, i.e. the process 300 identifies or interprets the item and the unencrypted argument (or result) is available for processing, as indicated by reference 334. According to an embodiment (as described above), the argument from the calling application may comprise an actual argument, or a pointer to a (larger) argument. The process 300 determines if the argument is an actual argument or a pointer to the actual argument. If the argument is a pointer (as determined in decision block 340), then the process 300 is configured to generate a recursive request to retrieve the specific argument, as indicated by reference 310. According to an exemplary implementation, the process 300 is configured to send the pointer as an argument from the credential provider 114 to the calling application 112 in order to retrieve the actual value of the argument. Such a procedure according to an exemplary implementation is described in more detail below with reference to FIG. 4. If the argument is an actual argument, the process 300 is configured to add or otherwise include the argument in a processing operation, as indicated by reference 350. The process 300 is configured to repeat the processing loop 320 until all the arguments are processed, as indicated by reference 360.

Reference is next made to FIG. 4, which shows a data flow process according to an embodiment of the present invention for transferring a large argument between the calling application 112 and the credential provider application 114. The data flow process is indicated generally by reference 400 and comprises an initial argument transfer, for example as described above, and indicated generally by reference 410. If the initial argument comprises a pointer, then the credential provider application 114 is configured with a process or code component or module to generate a large argument retrieval request, as indicated generally by reference 422. In response, the calling application 112 is configured to pass back or transfer the actual argument, using another operating system-level mechanism, as indicated by reference 424, e.g. if the actual argument still exceeds the size limit, e.g. of the IPC, another large argument retrieval request is generated, as indicated by reference 430. According to another aspect, this mechanism may be utilized to retrieve multiple large arguments from the application 112. The calling application 112 is configured to pass back the remainder or another part of the actual argument, as indicated by reference 434. The process is repeated until the entire actual argument is transferred from the calling application 112. Once the actual argument is transferred, the processing operation(s) are performed by the credential provider application 114, as indicated by reference 440, and the result(s) of the processing operation(s) are returned by the credential provider application 114 to the calling application 112, as indicated by reference 450.

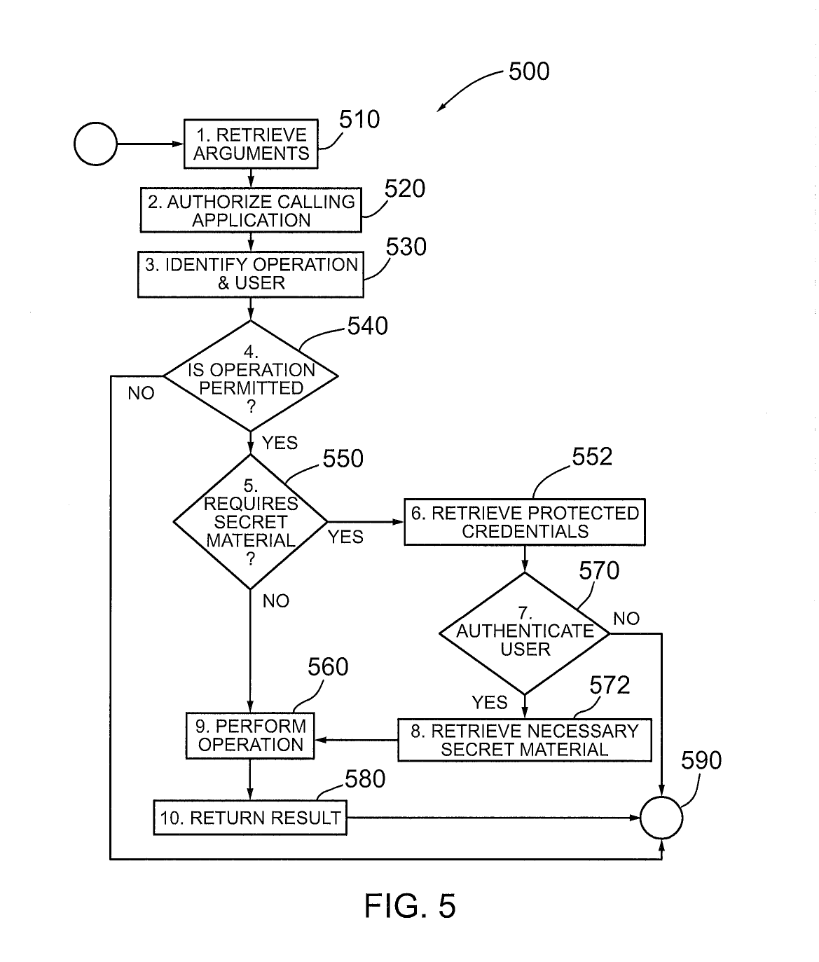

Reference is next made to FIG. 5, which shows an exemplary process configured for performing an operation utilizing one or more credentials according to an embodiment of the invention, and indicated generally by reference 500. The process 500 comprises retrieving, e.g. parsing, the arguments passed from the calling application (for example as described above with reference to FIG. 3), as indicated by reference 510. According to an exemplary implementation, the credential provider application 114 is configured to identify which one(s) of the calling applications 112 (or 113 in FIG. 1) have permissions to access the functionality of the credential provider application 114 (FIG. 1). As shown in FIG. 5, the process 500 may include an optional step or operation in 520 configured to authorize and/or authenticate the calling application 112, e.g. based on permissions. If the calling application does not possess the requisite permissions, the credential provider application 114 is configured to terminate the operation. As indicated by reference 530, the process 500 is configured to identify the operation requested to be executed or performed and also identify the credentials required of the user to perform the operation. In some applications or implementations, a user may have restricted access or granted permissions to perform or request only certain operations. Accordingly, the process 500 may include logic for determining if an operation is permitted for the associated user or request, as indicated generally by reference 540. If the operation is not permitted, the process 500 terminates or ends, as indicated by reference 590. For some operations, access to private or secret information or data, e.g. protected credentials, associated with a user may not be required, for instance, in the case where a digital signature needs to be verified. According to an embodiment, the process 500 includes logic for determining if secret material or information is required, as indicated by reference 550 in FIG. 5. If secret material is not required, then the process 500 proceeds to perform or execute the requested or required operation, as indicated by reference 560. On the other hand, if secret or private data is required, the process 500 is configured to retrieve the private data (e.g. protected user credentials), as indicated by reference 552. According to an embodiment, the credit provider application 114 is configured with access to the private data (e.g. the user's credentials). According to an exemplary implementation, the credential provider application 114 is provided with access using one or more of the following techniques: the user previously manually imported or entered their credential(s) into the credential provider application 114; the device was previously and automatically configured with the user's credentials; the credential provider application 114 is configured to retrieve, on demand, the credentials from the “cloud” 130 (FIG. 1); or the credential provider application 114 is configured to retrieve and cache the credentials from the cloud, and further configured to refresh the credentials on a periodic or an as needed basis. As shown and indicated by reference 570, the process 500 includes logic for authenticating the user. According to an embodiment, the credential provider application 114 is configured to request the user for authentication information and this information is used to confirm the identity of the user, and permit the credential provider application 114 to perform the action(s) or operation(s) associated with the user's credentials and as requested by the calling application 112. According to an embodiment, the authentication operation comprises identifying the calling application and operation. If the user declines the authentication request, then the credential provider application is prevented from performing the operation. According to another aspect, if the user permits the authentication request, but provides incorrect authentication information, then the credential provider application is also configured to prevent execution of the operation. On the other hand, if the user provides the correct authentication information, the process proceeds with execution of the operation. If the user is successfully authenticated, then the process 500 is configured to retrieve the required secret material or information, as indicated by reference 572, and the retrieved secret material is utilized (as needed) in the execution or performance of the operation proceeds as indicated by reference 560. If a copy of the secret material is utilized, then the process 500 is further configured to delete or destroy the secret material after usage. Upon completion of the processing operation(s), the result is returned, for example, to the calling application 112, as indicated generally by reference 580 in FIG. 5.

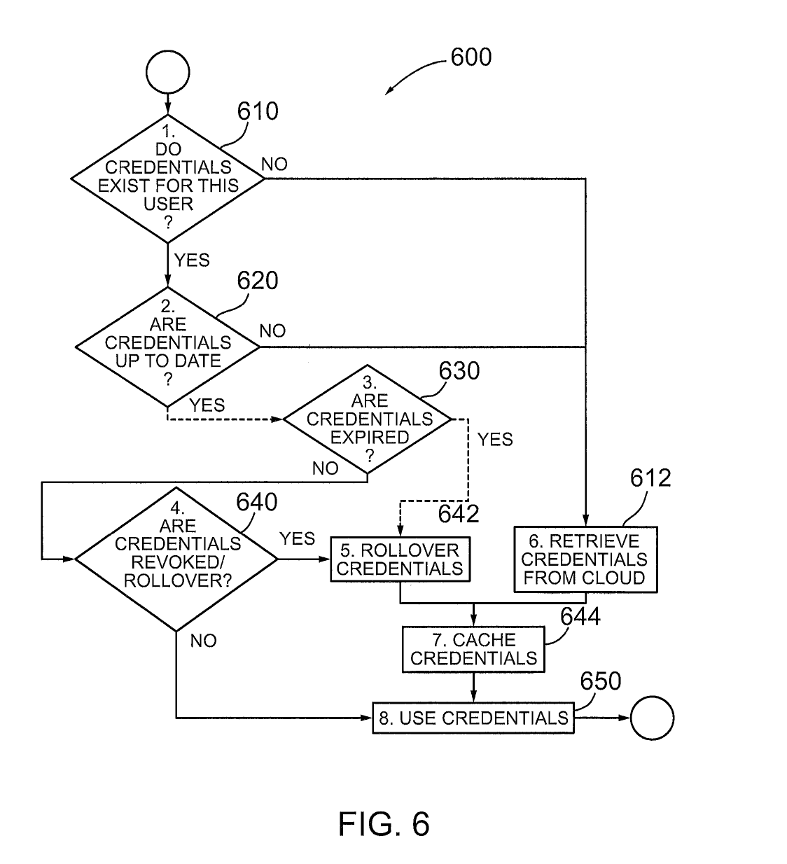

According to another aspect, the availability of the latest or most current credentials associated with a user may be important for a number of reasons when decrypting content sent to or associated with the user. The user credentials may be retrieved, for example, as described above with reference to FIG. 5. If the user has updated credentials, and those credentials were used to encrypt information for the user, the user will only be able to decrypt the content if they have the same up to date credentials. Credentials may be updated if previous credentials have expired, revoked, or an administrator has forced those credentials to roll over. It will be appreciated that if the credentials provider application 114 (FIG. 1) utilizes credentials that were previously imported, the credentials provider application will not be able to decrypt content encrypted with updated or changed credentials. According to another aspect of the present invention, the system (e.g. the credential provider application) may be configured with a process or method for storing credentials locally, and dynamically retrieving or refreshing the credentials if they have been changed or updated, as shown in FIG. 6.

Reference is next made to FIG. 6, which shows in flowchart form a process for storing credentials locally and dynamically retrieving the credentials if they have been changed. The process is indicated generally by reference 600, and according to an embodiment, the process is configured on the basis that the most recent or latest version of the credentials for a user are stored on the cloud 130 (FIG. 1). The process 600 includes logic as indicated by reference 610 configured to determine if the credentials for the user exist within the application 114 (FIG. 1). If not, the process 600 is configured to retrieve the credentials from the cloud, as indicated by reference 612, and described in more detail below. If the credentials exist within the current application (as determined in 610), then the process 600 includes logic configured to determine if the credentials are up to date, as indicated by reference 620. According to an embodiment, the logic comprises determining whether the user's credentials are the same as the credentials for the user stored on the cloud. According to an exemplary implementation, the logic is configured to make a comparison utilizing summary information of the existing credentials, such as a hash value or a thumbprint. If the credentials are not the same, then the process 600 is configured to retrieve the most recent or updated credentials from the cloud as indicated by reference 612. According to an exemplary implementation, the process 600 is configured to retrieve data from the cloud utilizing Internet Protocol (IP) and a secure channel, e.g. VPN, TLS, as will be understood by one skilled in the art. If the comparison operation in 620 determines that the credentials are the same, i.e. the credentials in the application match the credentials stored on the cloud, the current credentials may be utilized. According to another aspect, the process 600 may be configured with logic configured to determine if the credentials are currently valid, e.g. not expired, as indicated by reference 630. If logic (630) in the process 600 determines that the credentials are valid, e.g. not expired, then the credentials are ready for use. As shown in FIG. 6, the process 600 may configured with further logic configured to determine if the credentials have been revoked and/or should be rolled over, i.e. transformed, into a valid state before being used, as indicated by reference 640. For instance, the process 600 may have received an administrator request that the credentials be rolled over prior to use, or the administrator has authorized that the revoked credentials be rolled over. If yes, then the process 600 includes logic configured for rolling over the credentials as indicated by reference 642. The process 600 may be configured to “roll over” expired credentials (as described above for 630) as also depicted in FIG. 6. According to an exemplary implementation, the logic 642 for performing the rollover comprises generating or creating new secret material (e.g. a private key) and new public material (e.g. a public key or certificate) for the user. According to another aspect, the process 600 may be further configured to store and share the newly created secret material and the newly created public material on the cloud, in order to provide the capability for checking the credentials, as described above. According to another aspect, the process 600 may be configured to “roll over” the expired credentials themselves. According to an exemplary implementation, the process 600 is configured to locally cache or store the new secret material (and the new public material), as indicated by reference 644. As also depicted in FIG. 6, the process 600 includes logic configured to locally cache credentials retrieved from the cloud (as indicated by reference 612). The process 600 is configured to make the new or up-to-date credentials available for use and returned for use by the calling application, as indicated by reference 650.

It will be appreciated that the system and processes according to the embodiments described above comprise a mechanism including one or more of the following attributes: a system or process that does not necessarily require system, privileged or root permissions; a system or process that is consistent for the different applications in a system; a system or process that can be configured for an arbitrary number of applications, which does not need to be known in advance; that does not expose private data (e.g. keys or passwords) to the applications; and a system or process that is configured to utilize up-to-date credentials for PKI or cryptographic operations.

According to an embodiment, the functions, logic processing, databases, and encryption/decryption (and/or digital signing, and/or verification of signing) processes performed in the operation of the system and the associated processes and/or applications as described above may be implemented in computer software comprising one or more computer programs, objects, functions, modules and/or software processes. It will be appreciated by one skilled in that the various functions, logic processing, databases, and/or the encryption/decryption processes/operations (and other operations and functions) set forth may also be realized in suitable hardware, firmware/software stored in memory or other computer readable media and configured for one or more processing or computing devices or processors operating under stored program control, and/or firmware/software logic blocks, objects, modules or components or in combination thereof. The particular implementation details will be within the understanding of one skilled in the art.

The present invention may be embodied in other specific forms without departing from its spirit or essential characteristics. The embodiments described and disclosed are to be considered in all aspects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A device configured for executing an application, said device comprising:
an operating system configured to run the application, and the application being configured to run in a separated environment;
a credential provider module configured to run on the operating system, and comprising an inter-process communication path configured to transfer data between the application and said credential provider module;
said credential provider module comprising a verifiable identity configured to be verified by the application;
said credential provider module comprising a credential component configured to maintain one or more credentials associated with a user within said credential provider module, and a processing component configured to utilize said one or more credentials and further configured to perform one or more operations based on a request from said application; and
an encryption component configured to encrypt said data being transferred between said credential provider module and the application, said encryption being based on a shared secret known to said credential provider module and the application.

2. The device as claimed in claim 1, wherein said credential provider module comprises a credential update module configured to update said one or more credentials wherein updated versions of said one or more credentials are stored in another environment.

3. The device as claimed in claim 2, wherein said other environment comprises the cloud.

4. The device as claimed in claim 1, wherein said request comprises an argument, and the application being configured to construct said argument.

5. The device as claimed in claim 4, wherein said argument includes a size-limit, and said argument comprises an initial argument and one or more subsequent arguments, said initial argument being configured as a pointer for said credential provider module if said size-limit is exceeded, said one or more subsequent arguments comprising actual arguments and said pointer referencing said one or more actual arguments.

6. A system for providing distributed credential usage within a restricted computing environment, said system comprising:
an application configured to run and process data within a separated environment running on an operating system;
a credential provider application configured to transfer data to and from said application utilizing inter-process communication, said credential provider application having a verifiable identity, and being configured to store one or more credentials associated with said application or a user associated with said application, and further configured to contain said one or more credentials within the boundaries of said credential provider application;
said application being configured to verify the identity of said credential provider application, and based on said verification generate a request for performing an operation on data associated with said application;
said application being configured to transfer said request to said credential provider application through said inter-process communication;
said credential provider application being configured to perform said operation based on said request from said application to generate a result for said application, and said credential provider application utilizing said one or more credentials as needed within the boundaries of said credential provider application and without releasing any of said one or more credentials to said application or any other requesting party; and
said credential provider application being configured to send said result to said application.

7. The system as claimed in claim 6, wherein said environment comprises a sandboxed environment configured in one of an iOS based operating system and an Android based system.

8. The system as claimed in claim 6, further including an encryption component configured to encrypt said request or said result transferred between said credential provider module and the application via said inter-process communication, said encryption being based on a shared secret known to said credential provider module and the application.

9. The system as claimed in claim 7, wherein said one or more credentials comprise an updated version stored in another environment, and said credential provider module comprises a credential update module configured to refresh said one or more credentials based on said update version.

10. The system as claimed in claim 9, wherein said environment for storing said updated version of said one or more credentials comprises the cloud.

11. A computer-implemented method for performing an operation associated with a user in a restricted environment, said computer-implemented method comprising the steps of:
running an application in the restricted environment;
running a credential provider application, said credential provider application having an identity and being configured for storing one more credentials associated with the user and maintaining said one or more credentials within said credential provider application;
verifying the identity of said credential provider application;
generating a plurality of arguments at said application, said plurality of arguments being associated with the operation;
sending said plurality of arguments to said application;
performing the operation at said credential provider application utilizing one or more of said plurality of arguments and said one or more credentials associated with the user, and generating a result from said operation intended for said application; and
sending said result back to said application.

12. The computer-implemented method as claimed in claim 11, further including the step of establishing a secure inter-process communication channel between said application and said credential provider application for transferring said argument or said result.

13. The computer-implemented method as claimed in claim 12, wherein said argument and said result are encrypted using a shared secret and utilizing an inter-process communication for sending said encrypted argument and said encrypted argument.

14. The computer-implemented method as claimed in claim 11, wherein said step of sending said plurality of arguments comprises sending an initial argument and one or more subsequent arguments, said initial argument being configured as a pointer for said credential provider application, and said one or more subsequent arguments comprising actual arguments and said pointer referencing said one or more actual arguments.

15. The computer-implemented method as claimed in claim 10, further including the step of updating said one or more credentials, wherein an updated version of said one or more credentials is stored in another environment.

16. The computer-implemented method as claimed in claim 15, wherein said another environment comprises the cloud.

17. The computer-implemented method as claimed in claim 16, wherein said restricted environment comprises a sandbox environment configured under one of an iOS based operating system and an Android based operating system.

18. A computer program product for performing an operation associated with a user in a sandboxed environment, said computer program product comprising:
a computer readable storage media configured for storing instructions executable by a processor, said executable instructions comprising instructions for,
running an application in the sandboxed environment;
running a credential provider application, said credential provider application having an identity and being configured for storing one more credentials associated with the user and maintaining said one or more credentials within said credential provider application;
verifying the identity of said credential provider application;
generating an argument at said application, said argument being associated with the operation;
sending said argument to said application;
performing the operation at said credential provider application utilizing said argument and said one or more credentials associated with the user, and generating a result from said operation intended for said application; and
sending said result back to said application.

19. The computer program product as claimed in claim 18, further including the step of establishing a secure inter-process communication channel between said application and said credential provider application for transferring said argument or said result.

20. The computer program product as claimed in claim 19, further including the step of refreshing said one or more credentials, wherein an updated version of said one or more credentials being stored in another environment.
